(19) United States
(12) Patent Application Publication
(10) Pub. No.: US 2023/0314758 A1
(43) Pub. Date: Oct. 5, 2023

(54) LENS APPARATUS AND IMAGING APPARATUS

(71) Applicant: CANON KABUSHIKI KAISHA, Tokyo (JP)

(72) Inventor: TOMA KITAYAMA, Tokyo (JP)

(21) Appl. No.: 18/188,959

(22) Filed: Mar. 23, 2023

(30) Foreign Application Priority Data
Mar. 31, 2022 (JP) 2022-059448

(51) Int. Cl. G02B 7/10; G02B 7/02

(52) U.S. Cl. CPC G02B 7/10; G02B 7/026; G02B 7/022; G02B 7/14

(57) ABSTRACT

A lens apparatus includes a lens holding member holding a lens, a first movement member, a guide member having a straight groove, a second movement member, a biasing member, and a cam member that has a cam groove and rotates relative to the guide member. The first movement member holds the lens holding member and moves in an optical-axis direction together with the lens holding member. The first movement member includes a cam follower that engages with the straight groove and the cam groove and that moves in the optical-axis direction by relative rotation of the cam member to the guide member. The second movement member moves in the optical-axis direction together with the lens holding member and the first movement member. The biasing member biases the lens holding member to the second movement member so that the cam follower is biased to the straight groove and the cam groove.

### BACKGROUND

### Field

The present disclosure relates to a lens apparatus and an imaging apparatus.

### Description of the Related Art

There is a configuration in which a lens barrel is held in a groove portion formed in a cam ring or a fixed barrel by a roller, and there is known a structure in which the lens barrel is biased by a biasing member, such as a spring, in order to control a positional shift of the lens barrel due to backlash between the groove portion and the roller. An engagement portion between the roller and the groove portion or the like can have a clearance in consideration of the tolerance of components. There is known a configuration in which a lens barrel held by a roller contains a different lens barrel, and the lens barrel on the inner side is hung from the lens barrel on the outer side using a roller.

Japanese Patent No. 6759281 discusses a configuration of a lens apparatus that uses a biasing member in order to eliminate backlash that a cam follower engaged in a straight groove and a cam groove has with respect to a groove portion.

However, in the lens apparatus discussed in Japanese Patent No. 6759281, in a case where a lens barrel located inside a lens barrel held by the cam follower needs to be hung using a roller, and backlash needs to be controlled, two sets of biasing members are necessary, which increases the size. The two sets of biasing members are necessary in order to control two types of backlash, specifically, the backlash of the cam follower with respect to the straight groove and the cam groove, and the backlash of the roller with respect to a base barrel.

### SUMMARY

According to an aspect of the present disclosure, a lens apparatus includes a lens holding member configured to hold a lens, a first movement member configured to hold the lens holding member and to move in an optical-axis direction together with the lens holding member, a guide member having a straight groove, and a cam member having a cam groove and configured to rotate with respect to the guide member, wherein the first movement member includes a cam follower configured to engage with the straight groove and the cam groove, and moves in the optical-axis direction by relative rotation of the cam member to the guide member, a second movement member configured to move in the optical-axis direction together with the lens holding member and the first movement member, and a biasing member configured to bias the lens holding member to the second movement member so that the cam follower is biased to the straight groove and the cam groove.

Further features of the present disclosure will become apparent from the following description of exemplary embodiments with reference to the attached drawings.

### BRIEF DESCRIPTION OF THE DRAWINGS

FIG. 1 is a sectional view of a lens apparatus.

FIG. 2 is a perspective view of a part of a lens barrel.

FIG. 3 is a perspective view of a guide member.

FIG. 4 is a perspective view of a cam member.

FIG. 5 is a sectional view of a part of the lens barrel.

FIG. 6 is a perspective view of a roller.

FIG. 7 is a side view of a lens holding base.

FIG. 8 is a perspective view of a lens holding member.

FIG. 9 is a sectional view of a biasing member according to a first exemplary embodiment.

FIG. 10 is a perspective view of a second movement member.

FIG. 11 is a side view illustrating a direction of biasing by the biasing member.

FIG. 12 is a side view illustrating a direction of biasing by the biasing member.

FIG. 13 illustrates a surface indicating phases in which a roller, a cam follower, and the biasing member are disposed.

FIG. 14 is a side view illustrating a direction of biasing by the biasing member.

FIG. 15 is a perspective view illustrating a direction of biasing by a biasing member according to a second exemplary embodiment.

FIG. 16 is a sectional view illustrating a direction of biasing by a biasing member according to a third exemplary embodiment.

FIG. 17 is a schematic diagram illustrating the lens apparatus and an imaging apparatus.

### DESCRIPTION OF THE EMBODIMENTS

Exemplary embodiments of the present disclosure will be described in detail below with reference to the accompanying drawings. In the drawings, similar members are denoted by the same reference numerals, and the description thereof will not be repeated.

### First Exemplary Embodiment

### Configuration of Lens Apparatus

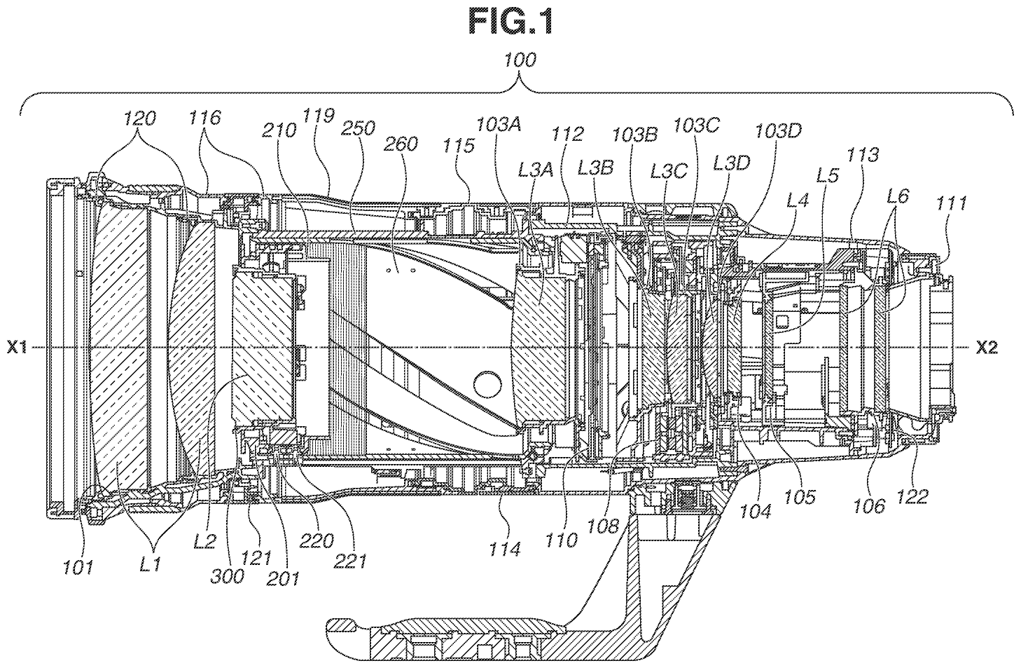

Exemplary embodiments of the present disclosure will be described in detail below with reference to the accompanying drawings. A configuration of an interchangeable lens 100 (an interchangeable lens for a single lens camera) that is a lens apparatus according to each exemplary embodiment of the present disclosure will be described with reference to FIG. 1. In the following description, an X1 side is a subject side (object side), and an X2 side is an image plane side.

The interchangeable lens 100 of the present exemplary embodiment is a lens apparatus having a six-unit configuration consisting of a first lens unit L1 to a sixth lens unit L6. A focus lens unit that is the fourth lens unit L4 and a floating lens unit that is the fifth lens unit L5 are moved in an optical-axis direction by a focusing operation (in-focus operation) on the interchangeable lens 100. The second lens unit L2 in the optical-axis direction is moved along each predetermined course by a zooming operation (zoom/magnification operation) on the interchangeable lens 100.

In this process, a controller 122 serving as control means controls drive of the fourth lens unit L4 and the fifth lens unit L5 to maintain a focus position after a change through the zooming operation and maintain each aberration at a certain level or lower.

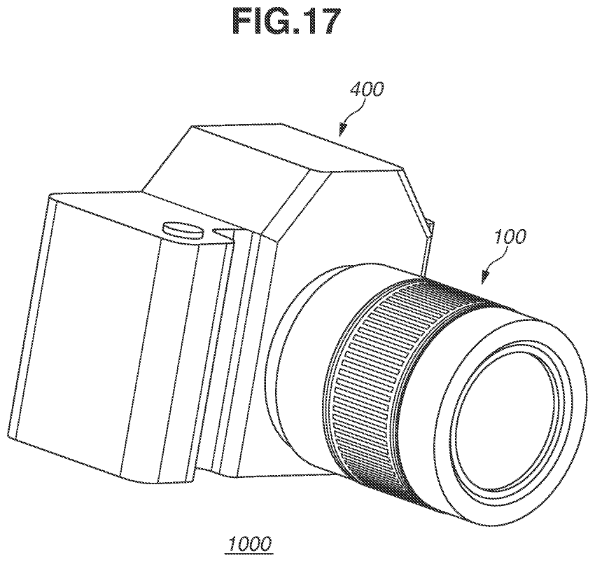

A camera body 400 illustrated in FIG. 17 is an imaging apparatus main body including an image sensor, such as a charge-coupled device (CCD) sensor or a complementary metal-oxide semiconductor (CMOS) sensor. The interchangeable lens 100 is held in a manner detachable by a user from the camera body 400, and the interchangeable lens 100 and the camera body 400 form an imaging apparatus 1000 (a camera system).

A lens mount 111 has a bayonet portion for attachment to the camera body 400, and is fixed to an exterior ring 113 by a screw. The exterior ring 113 is fixed to a fixed barrel 112 by a screw. A zoom index and operation switches (not illustrated) are attached to the exterior ring 113.

A guide barrel 250 (a guide member) is fixed to the fixed barrel 112 by a screw. A straight groove for guiding each lens unit in a straight direction is formed in the guide barrel 250. A cam groove corresponding to the course of the second lens unit L2 in the zooming operation is formed in a cam barrel 260 (a cam member) rotatable at a fixed position with respect to the guide barrel 250.

A zoom operation barrel 119 is held by diameter fitting to the guide barrel 250, in a manner rotatable about the optical axis by a fixed-position rotation roller (not illustrated).

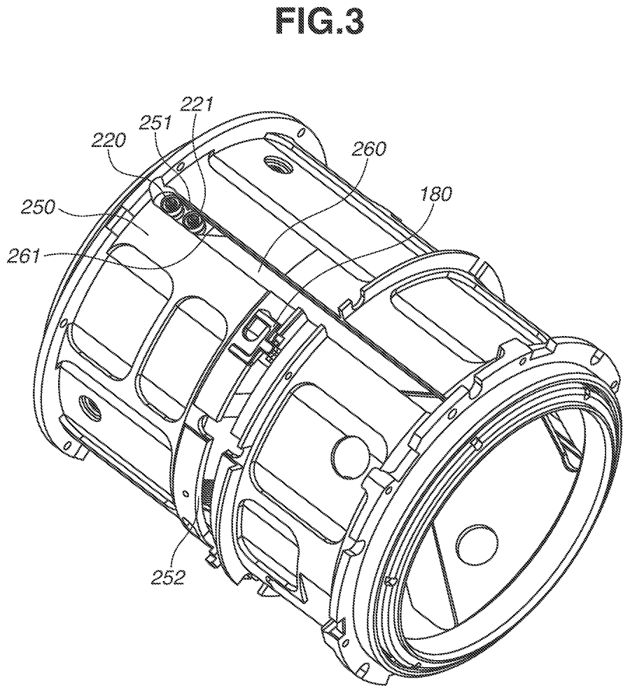

The zoom operation barrel 119 includes a zoom key (not illustrated) and a zoom sensor key 180 (see FIG. 3) to be connected to the cam barrel 260, so that a rotational force of the zoom operation barrel 119 is transmitted to the cam barrel 260 by the zooming operation, and the cam barrel 260 rotates about the optical axis. The zoom sensor key 180 and the zoom key are connected. As illustrated in FIG. 3, the cam barrel 260 is disposed inward from the guide barrel 250, and the guide barrel 250 has a peripheral groove 252 to avoid contact when the zoom sensor key 180 rotates.

By the action of the cam groove in the cam barrel 260, the cam follower of a second lens holding base 200 (a first movement member), and the straight groove in the guide barrel 250, the rotational force of the zoom operation barrel 119 is converted into a straight movement of the second lens holding base 200. Thus, a basic configuration in which the second lens holding base 200 is moved straight by the zooming operation is achieved.

### Configuration of Lens Unit

Next, each lens unit of the lens apparatus will be described. A first lens holding frame 101 holds the first lens unit L1. The first lens holding frame 101 is fixed to the guide barrel 250 by a screw. A lens press ring 120 has threads in the outer surface, and has a role in fixing the first lens unit L1 by being fixed through threaded engagement between the screw and threads provided on the inner surface of the first lens holding frame 101.

A protection ring is fixed to the first lens holding frame 101 by a screw (not illustrated). A concave portion for hood attachment is provided on the outer periphery side of the protection ring, and screws are provided on the inner periphery side thereof, so that accessories, such as a hood, a cap, and a filter, are attachable.

A second lens holding frame 300 holds the second lens unit L2 (a lens). As described above, the rotation of the zoom operation barrel 119 and the cam barrel 260 is converted into the straight movement of the second lens holding frame 300, and the second lens holding frame 300 is moved straight by the zooming operation, so that the focal length of the interchangeable lens 100 can be changed.

A third lens A holding frame 103A holds the third lens unit L3A. The third lens A holding frame 103A is fixed with respect to the guide barrel 250 by a screw. A diaphragm unit 110 including a diaphragm drive unit and a diaphragm blade unit is held thereby.

A third lens B holding frame 103B holds the third lens unit L3B. The third lens B holding frame 103B is held with respect to the guide barrel 250 by a roller (not illustrated).

A third lens C holding frame 103C holds the third lens unit L3C. The third lens C holding frame 103C forms a part of a vibration correction unit 108.

The vibration correction unit 108 holds the third lens C holding frame 103C in a direction orthogonal to the optical axis (an optical axis orthogonal direction), and performs vibration correction by driving the third lens C holding frame 103C, using a vibration correction drive unit including a magnet and a coil. The vibration correction unit 108 is held by being hung from the fixed barrel 112 by a roller.

A third lens D holding frame 103D holds the third lens unit L3D. The third lens D holding frame 103D is fixed with respect to a rear unit base (not illustrated) serving as a base member by a screw.

A fourth lens holding frame 104 serving as a movable lens barrel holds the fourth lens unit L4 that is the focus lens unit. The fourth lens holding frame 104 is guided to move straight by a main guide bar and a sub guide bar serving as guide members. The fourth lens holding frame 104 is driven in the optical-axis direction with respect to the rear unit base by a drive (a drive unit).

Here, a driving force transmission mechanism includes a stator and a mover that form a motor, and a motor drive transmission portion that is a part of the mover. The driving force transmission mechanism further includes a rack mechanism which is a drive transmission member for transmitting a driving force from the motor drive transmission portion to the fourth lens holding frame 104, and a rack biasing spring that removes backlash of the rack mechanism and the motor drive transmission portion by biasing.

The fourth lens holding frame 104 serving as the movable lens barrel includes a scale for position detection in the optical-axis direction. An optical sensor corresponding to the scale is disposed at the rear unit base with a flexible printed circuit board (FPC) interposed therebetween. The scale and the optical sensor form a focus position detector.

A fifth lens holding frame 105 serving as a movable lens barrel holds the fifth lens unit L5 which is a floating unit. The fifth lens holding frame 105 is guided to move straight by a main guide bar and a sub guide bar which serve as guide members. The fifth lens holding frame 105 is driven in the optical-axis direction with respect to the rear unit base by a drive means (a drive unit).

Here, a driving force transmission mechanism is configured in a manner similar to the driving force transmission mechanism for driving the fourth lens holding frame 104 holding the fourth lens unit L4.

A sixth lens holding frame 106 holds the sixth lens unit L6. The sixth lens holding frame 106 is fixed with respect to the rear unit base by a screw.

In the present exemplary embodiment, a motor using a piezoelectric element is used in driving the fourth lens holding frame 104 and the fifth lens holding frame 105, and the mover is configured to be driven in the optical-axis direction with respect to the stator. However, the drive means is not limited to the motor using the piezoelectric element. For example, a stepping motor may be used as a drive mechanism, and a mechanism of connection to a rack by having a lead screw shaft and a screw thereof serving as the mover and the motor drive transmission portion may be adopted. In using the stepping motor, a detection system can be eliminated, and the stepping motor can be controlled as open driving.

The cam barrel 260 is provided with the zoom sensor key 180 fitting to a mover of a resistance type linear sensor (a potentiometer) which is a zoom position detector (not illustrated) fixed to the guide barrel 250, and the output of the resistance type linear sensor changes depending on the amount of rotation of the cam barrel 260. The cam barrel 260 rotates in conjunction with the rotation of the zoom operation barrel 119, so that zoom position information can be detected.

A focus operation barrel 114 is held to be rotatable at a fixed position on the outside of an intermediate exterior ring 115. The focus operation barrel 114 detects the amount and direction of rotation of the focus operation barrel 114, using a light detection element in the guide barrel 250, and a scale on the inner surface of the focus operation barrel 114. For example, monochrome light and dark are used for the scale on the inner surface of the focus operation barrel 114.

A multipurpose operation barrel 121 is held by a front exterior barrel 116 to be rotatable at a fixed position on the outside of the first lens holding frame 101. The multipurpose operation barrel 121 has a plurality of comb teeth.

A photo-interrupter in the first lens holding frame 101 detects the plurality of comb teeth, so that the amount and direction of rotation of the multipurpose operation barrel 121 with respect to the first lens holding frame 101 can be detected.

The controller 122 is responsible for control of the entire interchangeable lens 100 including focus drive control, the diaphragm unit 110, the vibration correction unit 108, and other units, and is fixed to the rear unit base by a screw.

### Configuration of Lens Barrel

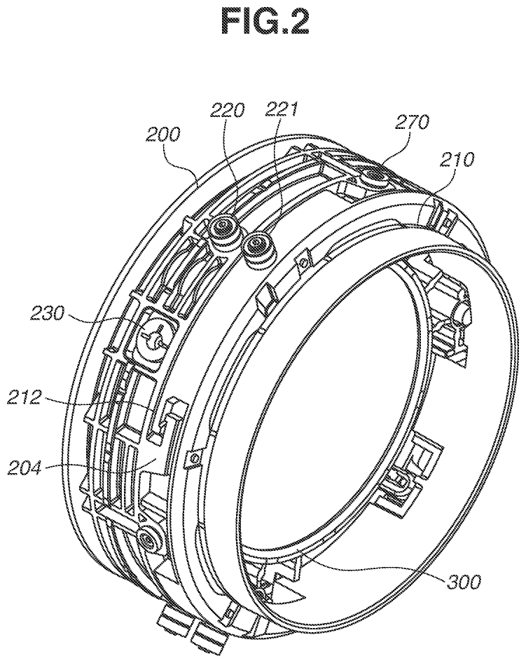

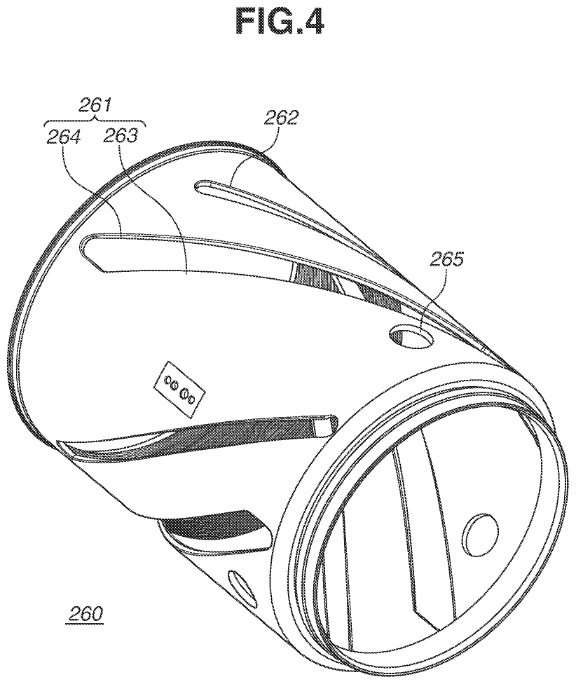

Next, a configuration related to the present exemplary embodiment will be described with reference to FIG. 2 to FIG. 4. FIG. 2 is a perspective view of extracted units related to the zooming operation involved in the present exemplary embodiment. FIG. 3 is a perspective view of the guide barrel 250. FIG. 4 is a perspective view of the cam barrel 260. The second lens holding frame 300 (the lens holding member) is held on the second lens holding base 200 (the first movement member) with a roller 230 (a holding member) interposed therebetween. As will be described below, the present exemplary embodiment adopts a configuration in which the position of the second lens holding frame 300 with respect to the second lens holding base 200 is adjustable by rotating the roller 230.

A first cam follower 220 is attached to the second lens holding base 200. The first cam follower 220 engages with a guide groove 251 (a straight groove) formed in the guide barrel 250 and a cam groove 261 formed in the cam barrel 260. The first cam follower 220 (the second lens holding base 200) is guided to move straight in the optical-axis direction by the guide groove 251, and can move back and forth in the optical-axis direction by the rotation of the cam barrel 260 relative to the guide barrel 250.

A second cam follower 221 is attached to a biasing barrel 210 (a second movement member). The second cam follower 221 engages with the guide groove 251 formed in the guide barrel 250 and the cam groove 261 formed in the cam barrel 260. The rotation of the guide barrel 250 about the optical axis with respect to the second lens holding base 200 is limited. As illustrated in FIG. 2, the first cam follower 220 and the second cam follower 221 are disposed apart in the optical-axis direction in the same phase. In other words, the guide groove 251 formed in the guide barrel 250 is shared. In a case where a configuration in which the first cam follower 220 and the second cam follower 221 vary in phase and guide using the different guide grooves 251 is adopted, the number of the guide grooves 251 increases (e.g., three to six grooves). Increase in the number of the guide grooves 251 may decrease the strength of the guide barrel 250, so that a space for increasing the strength is to be added or the guide barrel 250 is to be thickened.

The configuration in which the cam barrel 260 is disposed inward from the guide barrel 250 as in the present exemplary embodiment facilitates arrangement of components, such as a sensor and an FPC arranged outward from the guide barrel 250. On the other hand, the peripheral groove 252 for allowing the zoom sensor key 180 for connecting the cam barrel 260 and the zoom operation barrel 119 to run therethrough is to be provided on the guide barrel 250. The guide groove 251 and the peripheral groove 252 cannot overlap. Thus, if the number of the guide grooves 251 is increased, the rotation angle of the zooming operation is limited. It is therefore desirable that the first cam follower 220 and the second cam follower 221 be disposed in the same phase to share the guide groove 251 as in the present exemplary embodiment.

The second lens holding base 200 and the biasing barrel 210 are biased by a biasing member 240 to be described below, so that forces for causing the second lens holding base 200 and the biasing barrel 210 to move away from each other in the optical-axis direction are generated. The second lens holding base 200 has a hook portion 204, and the biasing barrel 210 has a hook portion 212. These hook portions 204 and 212 abut on each other, so that a force for biasing in the optical-axis direction is receivable, thus enabling unitization before components, such as the second lens holding base 200, are incorporated into the guide barrel 250 and the cam barrel 260. Thus, ease of assembly improves. The hook portion 204 and the hook portion 212 are configured not to be in contact with each other when incorporated into the cam barrel 260 and the guide barrel 250.

Accordingly, the second lens holding base 200 moves along a subject-side wall surface 264 of the cam groove 261, and the biasing barrel 210 moves along an image-plane-side wall surface 263 of the cam groove 261.

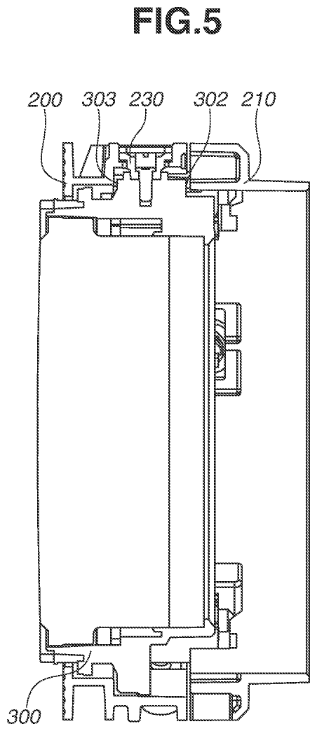

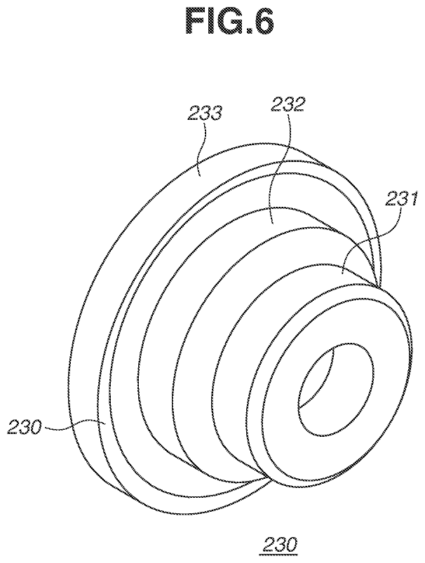

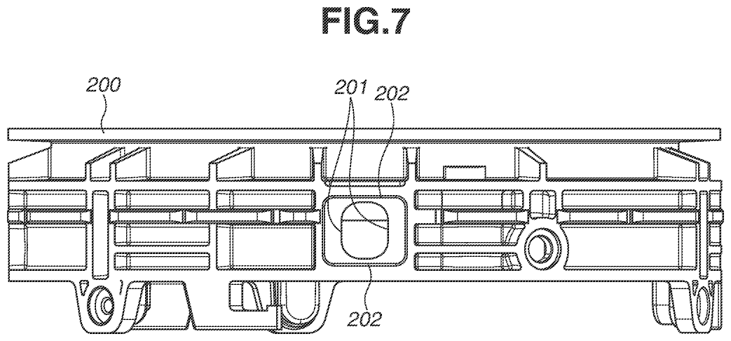

Next, connection between the second lens holding base 200 and the second lens holding frame 300 of the present exemplary embodiment will be described with reference to FIG. 5 to FIG. 7. FIG. 5 is a sectional view illustrating the relationship between the second lens holding base 200 and the second lens holding frame 300. FIG. 6 is a perspective view of the roller 230. FIG. 7 is a side view of the second lens holding base 200.

The second lens holding frame 300 is held on the second lens holding base 200 by the roller 230, as illustrated in FIG. 5. The roller 230 of the present exemplary embodiment has a first fitting portion 231, a second fitting portion 232, and a third fitting portion 233. The first fitting portion 231 (a holding frame fitting portion) engages with the second lens holding frame 300 in a slidable state. The second fitting portion 232 engages with a first groove 201 (see FIG. 7) formed in the second lens holding base 200 with a predetermined clearance therebetween. The third fitting portion 233 (a base fitting portion) engages with a second groove 202 (see FIG. 7) formed in the second lens holding base 200 with a predetermined clearance therebetween.

The second fitting portion 232 and the third fitting portion 233 of the roller 230 illustrated in FIG. 6 are decentered, and thus the position of the second lens holding frame 300 with respect to the second lens holding base 200 is adjustable by the roller 230 being rotated with respect to the second lens holding frame 300. In this way, the roller 230 has a structure with which inclination of the second lens holding frame 300 is adjustable with respect to the second lens holding base 200.

A sub roller 270 (see FIG. 2) is attached to the second lens holding base 200. The sub roller 270 is disposed on the second lens holding base 200 to have a predetermined clearance from a sub roller groove 262 (see FIG. 4) formed in the cam barrel 260. The sub roller 270 is not in contact with the sub roller groove 262 in normal use. However, for example, when the interchangeable lens 100 receives a shock due to a fall or the like, the sub roller 270 comes into contact with the sub roller groove 262, and receives an impact on the second lens holding base 200. This brings an effect of reducing damage to components and an unintended collision between components. If the sub roller groove 262 and the cam groove 261 are too close to each other, the thickness of the cam barrel 260 is reduced, which can lead to insufficient strength. Thus, it is desirable that the cam groove 261 and the sub roller groove 262 be disposed apart.

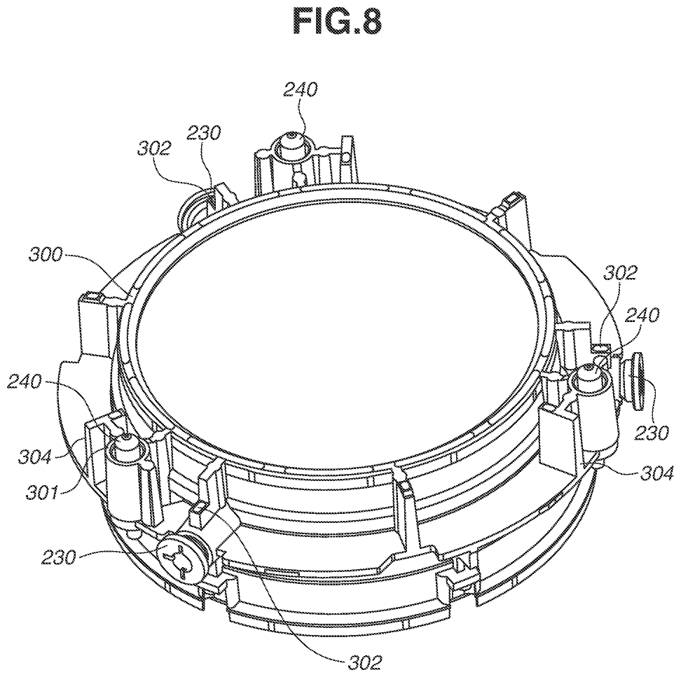

Next, the biasing member in the present exemplary embodiment will be described with reference to FIG. 8. FIG. 8 is a perspective view of the second lens holding frame 300 and the biasing member 240. In the second lens holding frame 300, the roller 230 is disposed in each of three phases equally divided by 120 degrees. In the second lens holding frame 300, the biasing members 240 are each disposed in a phase different from the phase of the roller 230. An image-plane-side abutment surface 302 and a subject-side abutment surface 303 are formed in the second lens holding frame 300 as illustrated in FIG. 5. The image-plane-side abutment surface 302 reduces unintended collision between components and damage to components, by abutting the biasing barrel 210 when receiving a shock or the like. The subject-side abutment surface 303 also reduces unintended collision between components and damage to components, by abutting the second lens holding base 200 when receiving a shock or the like.

### Configuration of Biasing Member

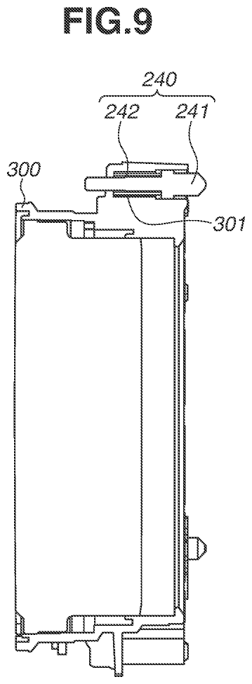

FIG. 9 is a sectional view of the second lens holding frame 300 and the biasing member 240 according to the present exemplary embodiment. The biasing member 240 of the present exemplary embodiment includes a biasing pin 241 and a biasing spring 242. The biasing pin 241 and the biasing spring 242 are held by a biasing member holding unit 301 (a holding unit) included in the second lens holding frame 300. The biasing pin 241 is held by the biasing member holding unit 301 to be movable back and forth in the optical-axis direction. In the present exemplary embodiment, the biasing member holding unit 301 has a cylindrical shape having a bottom, and the biasing pin 241 has a stepped cylindrical shape. These cylindrical portions fit to each other by diameter, and are slidably held. The biasing spring 242 is a compression coil spring, and abuts a surface of the biasing member holding unit 301, thus biasing the biasing pin 241 in the optical-axis direction with respect to the second lens holding frame 300.

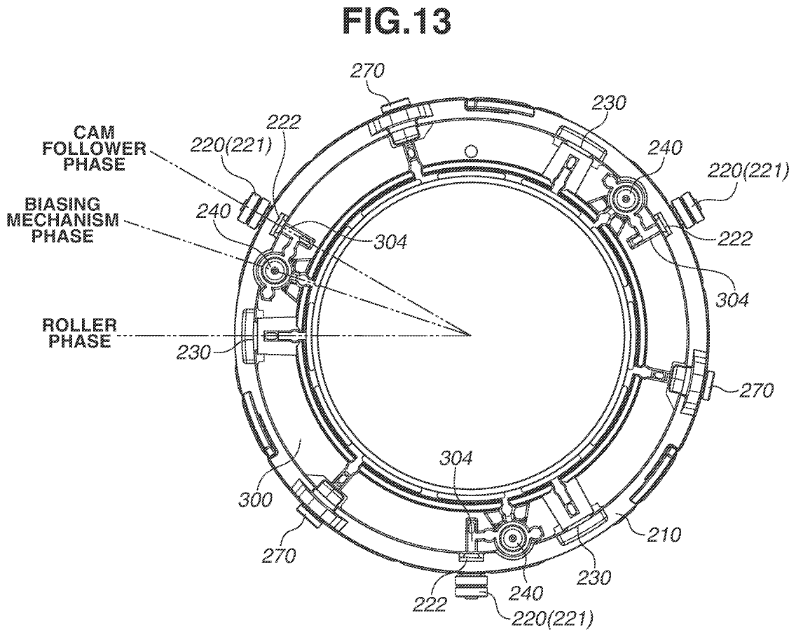

A nut back abutment surface 304 is formed on the second lens holding frame 300 as illustrated in FIG. 8. The nut back abutment surface 304 is located inward from the first cam follower 220 and the second cam follower 221, in the same phase as the phase of the first cam follower 220 and the second cam follower 221. In the present exemplary embodiment, the first cam follower 220 and the second cam follower 221 each include a shaft having a tapped hole and a bearing. In the second lens holding base 200, a wall surface of the second lens holding base 200 is sandwiched between the tapped hole of the first cam follower 220 and a nut 222 (see FIG. 13) engaging with each other, so that the first cam follower 220 is fixed. The nut back abutment surface 304 can be used as a receiving surface during assembly work by being disposed inward from the first cam follower 220 and the second cam follower 221, in the same phase of the first cam follower 220 and the second cam follower 221, so that the stability of the work can be improved.

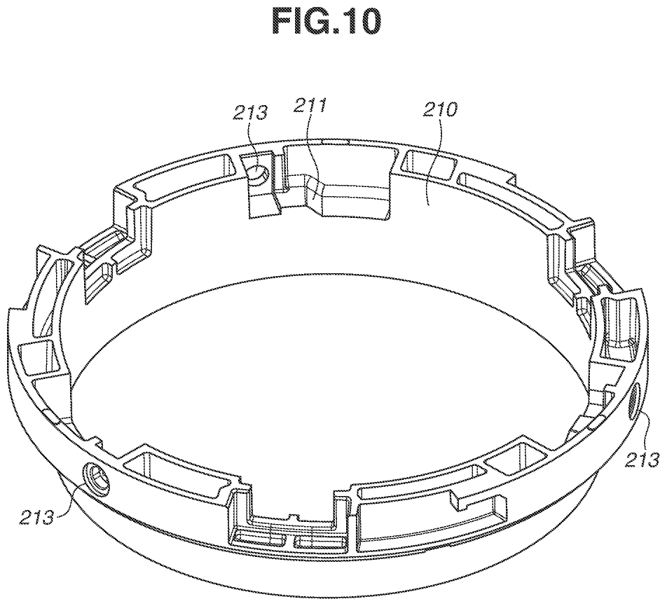

FIG. 10 is a perspective view of a structure of the biasing barrel 210. The biasing barrel 210 has a biasing member receiving portion 211 to abut the biasing pin 241. In the present exemplary embodiment, the biasing member receiving portion 211 is a surface (a slope) inclined with respect to the optical axis. A cam follower attachment portion 213 is formed in the biasing barrel 210. To the cam follower attachment portion 213, the second cam follower 221 is to be attached.

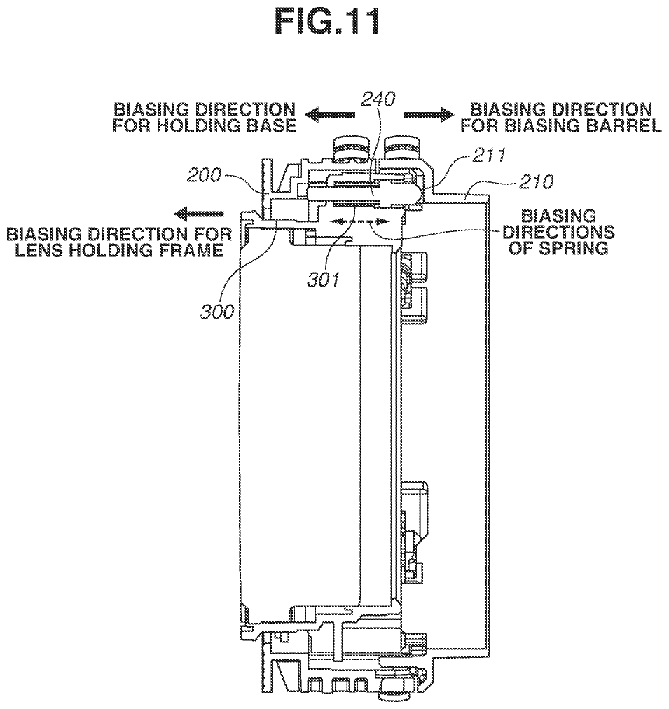

FIG. 11 is a diagram illustrating a biasing force, in the optical-axis direction, acting on the second lens holding base 200, the biasing barrel 210, and the second lens holding frame 300. The biasing member 240 is held on the biasing member holding unit 301 of the second lens holding frame 300, and abuts the biasing member receiving portion 211 of the biasing barrel 210. Thus, the second lens holding frame 300 and the biasing barrel 210 are biased in directions moving away from each other along the optical axis. This biasing force biases the biasing barrel 210 to the image plane side, and biases the second lens holding frame 300 to the subject side. The second cam follower 221 in the biasing barrel 210 is biased to the image plane side, thus abutting the image-plane-side wall surface 263 of the cam groove 261. The second lens holding frame 300 is held on the second lens holding base 200 with the roller 230 interposed therebetween. The roller 230 in the second lens holding frame 300 is biased to the subject side to abut the second groove 202 on the subject side. As described above, there is some clearance between the roller 230 and the second groove 202, and while there is backlash between the second lens holding base 200 and the second lens holding frame 300, the backlash is controlled by the biasing force exerted by the biasing member 240.

In this way, the second lens holding frame 300 is biased by the biasing member 240 to the subject side, so that the roller 230 abuts the second groove 202 formed in the second lens holding base 200 on the subject side. The second lens holding base 200 is biased to the object side along the optical axis by this biasing force. The first cam follower 220 in the second lens holding base 200 abuts the subject-side wall surface 264 of the cam groove 261. The first cam follower 220 has backlash with respect to the cam groove 261, but the backlash in a direction along the optical axis of the second lens holding base 200 is controlled by this biasing force.

In this manner, the biasing member 240 which generates the biasing force in the direction along the optical axis enables the control of both the backlash of the second lens holding frame 300 with respect to the second lens holding base 200 and the backlash of the second lens holding base 200 with respect to the guide groove 251 and the cam groove 261.

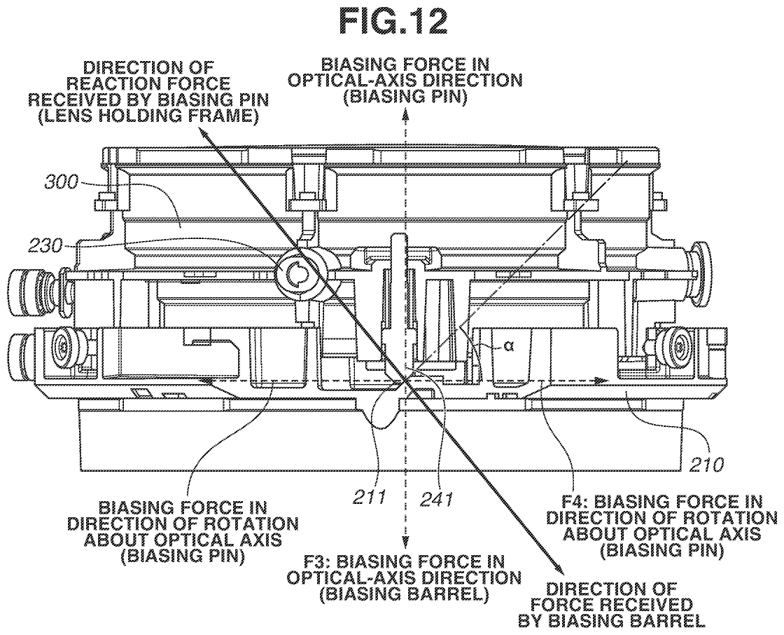

As described above, the biasing member receiving portion 211 of the biasing barrel 210 is formed with the slope having a predetermined angle from the optical axis. FIG. 12 is a sectional view illustrating the relationship between the biasing pin 241 and the biasing member receiving portion 211. Although the biasing pin 241 is biased in the optical-axis direction by the biasing spring 242, a reaction force received by the biasing pin 241 exerts in the normal direction of the biasing member receiving portion 211 because the biasing member receiving portion 211 is the slope. Thus, not only the above-described biasing force in the direction along the optical axis, but also a biasing force in the direction of rotation about the optical axis (a direction perpendicular to the optical axis) is generated. The first groove 201 in the second lens holding base 200 engages with the second fitting portion 232 of the roller 230 in the second lens holding frame 300. Between the second fitting portion 232 and the first groove 201, a clearance is provided to some extent. This clearance between the second fitting portion 232 and the first groove 201 results in the occurrence of backlash in a decentration direction about the optical axis of the second lens holding frame 300 with respect to the second lens holding base 200. Backlash in these components may lead to a movement of the position of the second lens holding frame 300 when the attitude of the interchangeable lens 100 is changed or the zooming operation is performed. It is possible to reduce not only the backlash in the optical-axis direction but also the backlash in the decentration direction, by generating the biasing force not only in the optical-axis direction but also in the rotation direction about the optical axis as in the present exemplary embodiment.

The phase relationship between components related to the lens apparatus of the present exemplary embodiment will be described with reference to FIG. 13. FIG. 13 is a front view of the second lens holding base 200, the second lens holding frame 300, and some of components accompanying those. The phase of the roller 230 and the phase of each of the biasing member 240 and the first cam follower 220 (the second cam follower 221) are adjacent to each other as illustrated in FIG. 13. It is desirable that these components be close to each other in consideration of a case where a shock due to a fall or the like is received. For example, when the acceleration of the lens apparatus increases in a direction to the subject side, the acceleration of the second lens holding frame 300 holding the second lens unit L2 also increases in the direction to the subject side. Thus, the second lens holding base 200 receives a force at the second groove 202. The second lens holding base 200 is held on the guide groove 251 and the cam groove 261 by the first cam follower 220. Hence, the force is received at the position of the second groove 202, using the phase of the first cam follower 220 as a supporting point. As the phase of the roller 230 and the first cam follower 220 are closer to each other, deformation of the second lens holding base 200 when receiving a force is smaller, so that the possibility of damaging the lens apparatus is reduced.

The second lens holding frame 300 is held on the second lens holding base 200 by the roller 230, and biased by the biasing member 240. A force is received at the position of the biasing member 240 using the position of the roller 230 as a supporting point, and because of this relationship, deformation of the second lens holding frame 300 is also smaller as the roller 230 and the biasing member 240 are closer to each other when receiving the force.

The biasing barrel 210 is held on the guide groove 251 and the cam groove 261 by the second cam follower 221 attached to the cam follower attachment portion 213, and receives a biasing force from the biasing member 240 at the biasing member receiving portion 211. Thus, deformation due to the biasing is smaller as the phase of the biasing member 240 and the phase of the cam follower attachment portion 213, that is, the second cam follower 221, are closer to each other. The possibility of damaging the lens apparatus when the lens apparatus receives a shock due to a fall or the like can be reduced.

The roller 230 is configured so that the position of the second lens holding frame 300 is adjustable by the roller 230 being rotated after the second lens holding base 200 is incorporated into the guide barrel 250 and the cam barrel 260. Thus, an adjustment hole 265 (see FIG. 4) is formed in the cam barrel 260 so that the second lens holding base 200 can access the roller 230 after being incorporated into the guide barrel 250 and the cam barrel 260. If the cam groove 261 and the adjustment hole 265 are too close to each other, the strength of the cam barrel 260 may locally decrease. In other words, the strength of the cam barrel 260 may decrease if the roller 230 and the first cam follower 220 are too close to each other in terms of placement phase.

As described above, it is desirable to arrange the first cam follower 220, the biasing member 240, and the roller 230 close to each other in terms of placement phase, and the arrangement of the biasing member 240 between the second cam follower 221 and the roller 230 enables each component to be disposed with a minimum arrangement. When the lens apparatus is viewed in a direction along the optical-axis direction, it is desirable for the phase of the second cam follower 221 and the phase of the roller 230 to fall within 30 degrees. In other words, it is desirable that an angle formed by a line linking the second cam follower 221 and the optical axis and a line linking the roller 230 and the optical axis fall within 30 degrees when the lens apparatus is viewed in the direction along the optical-axis direction. If the second cam follower 221 and the biasing member 240 are disposed in the same phase, it is desirable to arrange these components not to overlap each other in the radial direction, and thus the size increases in the radial direction.

Thus, making the second cam follower 221 and the biasing member 240 different in terms of placement phase (different in the circumferential direction) can provide a configuration achieving a small size.

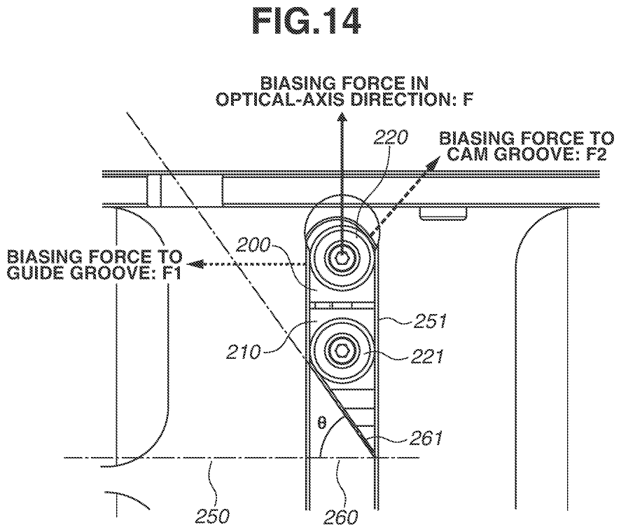

Next, a biasing force of the first cam follower 220 with respect to the guide groove 251 and the cam groove 261 will be described with reference to FIG. 14. As illustrated in FIG. 14, an angle θ (a gradient angle) formed by the cam groove 261 is defined, and a biasing force in the optical-axis direction is denoted as F. In this case, when a force for biasing the first cam follower 220 to the guide groove 251 is denoted as F1, F1=Ftan θ is established. When a force for biasing the first cam follower 220 to the cam groove 261 is denoted as F2, F2=F/cos θ is established.

In other words, the force F2 is greater with respect to the force F1 as the angle θ is smaller. The force F1 is greater with respect to the force F2 as the angle θ is larger. In a case where the force F1 is small, the first cam follower 220 easily floats from the guide groove 251, which may lead to a movement of the position of the second lens holding base 200 in the decentration direction. When the force F2 is small, the first cam follower 220 easily floats from the cam groove 261, which may make the second lens holding base 200 move in the optical-axis direction or incline with respect to the optical axis. When the ratio between the force F1 and the force F2 is excessively unbalanced, the spring force is to be increased to satisfy one of the forces, and the other becomes stronger than necessary. This may limit the spring design, and thus it is desirable that the force F1 and the force F2 be well balanced. In the present exemplary embodiment, the first cam follower 220 and the second cam follower 221 make rolling motion using the bearing. Thus, the influence of friction is ignored in the above-described calculation.

Next, the relationship between the biasing member receiving portion 211 of the biasing barrel 210 and the biasing force by the biasing member 240 will be described with reference to FIG. 12. In the present exemplary embodiment, the biasing member receiving portion 211 is a slope inclined at a certain angle from the optical axis. In the present exemplary embodiment, the biasing member receiving portion 211 is a slope inclined at an angle α with respect to a plane orthogonal to the optical axis, as illustrated in FIG. 12. The coefficient of friction between the biasing pin 241 and the biasing member receiving portion 211 is defined as μ. The biasing force generated by the biasing member 240 in the optical-axis direction is denoted as F. In this case, when a force for biasing the biasing barrel 210 in the optical-axis direction is denoted as F3, the relationship is expressed as F3=F(μtan α+1). When a force in the direction of rotation about the optical axis is denoted as F4, the relationship is expressed as F4=F(tan α−μ). In other words, the ratio between the force F3 and the force F4 is adjustable by adjustment of the angle α. The force F4 generated here can increase the magnitude of the force F1 for biasing the first cam follower 220 to the guide groove 251.

In other words, the force with respect to the guide groove 251 of the first cam follower 220 is adjustable with adoption of the slope angle a of the biasing member receiving portion 211 to match with the angle θ (cam gradient angle) formed by the cam groove 261. In contrast to this, the force in the optical axis cannot be well adjusted. For example, when the coefficient μ is minute in the above-described formula expressing the force F4, F4≈F is determined. A biasing force to be applied to the cam groove 261 is a moment acting on the held unit, specifically, “unit mass×(barycentric position−position of supported component)”.

As this value increases, a force for moving the first cam follower 220 away from the groove when a force is applied by a shock or the like also increases.

In the present exemplary embodiment, the total mass of the second lens holding frame 300 and the second lens unit L2 is not greatly different from the total mass of the second lens holding base 200, the second lens holding frame 300, and the second lens unit L2. This is because only the second lens holding frame 300 holds the optical element. If the distance between the barycentric position of the second lens holding frame 300 including the component held thereby and the roller 230, and the distance between the barycentric position of these including the second lens holding base 200 and the first cam follower 220 are close, the biasing forces, in the optical-axis direction, to be applied are almost the same. In other words, there is no need to increase the force of the biasing member more than necessary because of the limitation by the one side, and thus the size of the biasing member can be reduced.

### Second Exemplary embodiment

The structure in which the biasing pin 241 and the biasing spring 242 are used for the biasing member 240 and the biasing member receiving portion 211 formed in the biasing barrel 210 is used is described in the first exemplary embodiment. In a second exemplary embodiment, an example in which a helical extension spring is used will be described.

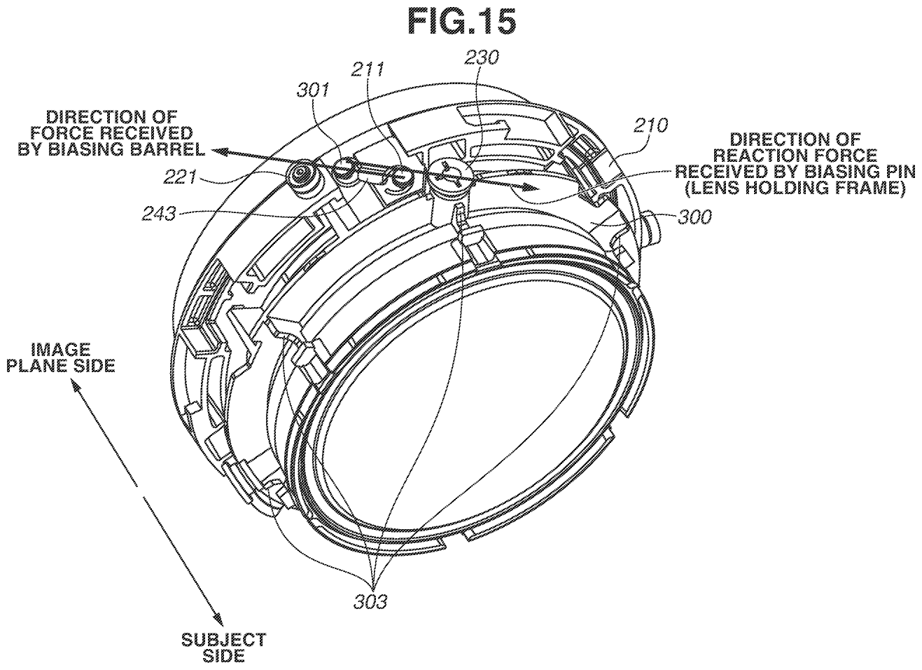

FIG. 15 is a perspective view of a second lens holding frame 300 and a biasing barrel 210 with accompanying components thereof, and a biasing member 240. In the present exemplary embodiment, the biasing member 240 includes a tensile spring 243. The second lens holding frame 300 illustrated in FIG. 15 is held on a second lens holding base 200 with a roller 230 interposed therebetween. In the biasing barrel 210 of the present exemplary embodiment, a biasing member receiving portion 211 is formed, and a biasing member holding unit 301 is formed in the second lens holding frame 300. Each of the biasing member receiving portion 211 and the biasing member holding unit 301 of the present exemplary embodiment is a shaft screw, and the tensile spring 243 is hooked to a shaft portion.

Thus, the second lens holding frame 300 is biased to the subject side in the direction along the optical axis, and the biasing barrel 210 is biased to the image plane side. The tensile spring 243 is disposed to generate a tension in a direction inclined with respect to the optical axis. Thus, as in the first exemplary embodiment described above, a biasing force is generated in the direction of rotation about the optical-axis direction or the optical axis in the biasing barrel 210 and the second lens holding frame 300. This biasing force makes it possible to hold the second lens holding base 200, the second lens holding frame 300, and the biasing barrel 210 in a cam barrel in which a cam groove is formed and a guide barrel in which a guide groove is formed, while controlling backlash, in a lens apparatus of the present exemplary embodiment as well.

### Third Exemplary embodiment

The structure in which the biasing pin 241 and the biasing spring 242 are used for the biasing member 240 and the biasing member receiving portion 211 formed in the biasing barrel 210 is used is described in the first exemplary embodiment. In a third exemplary embodiment, an example in which the biasing direction of a biasing member 240 is different will be described.

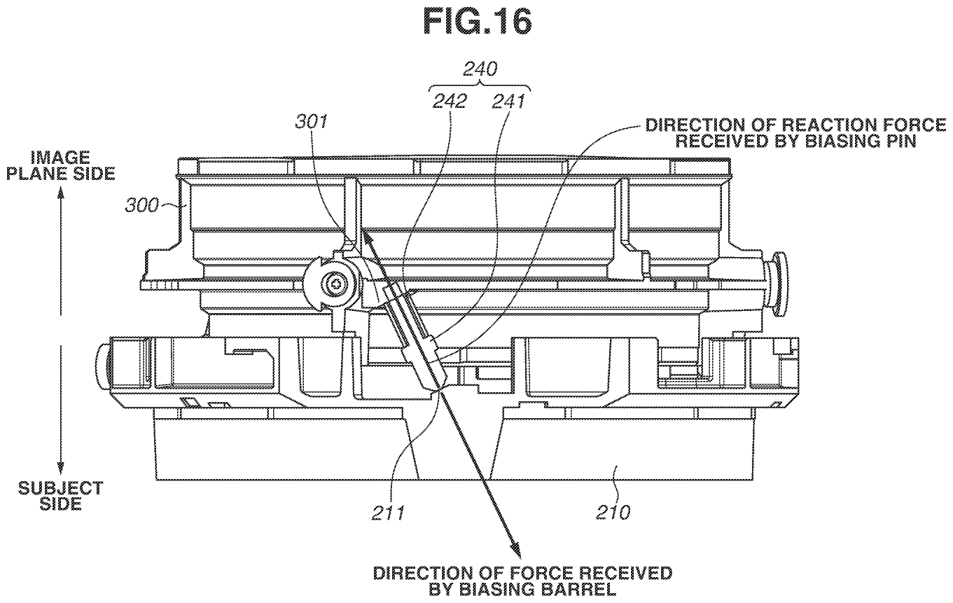

FIG. 16 is a perspective view of a second lens holding frame 300 and a biasing barrel 210 with accompanying components, and the biasing member 240. FIG. 16 is a partially simplified view. In the present exemplary embodiment, the biasing member 240 includes a biasing pin 241 and a biasing spring 242.

The second lens holding frame 300 illustrated in FIG. 16 is held on a second lens holding base 200 with a roller 230 interposed therebetween. The biasing member 240 of the present exemplary embodiment is disposed in a manner inclined with respect to the optical axis. A biasing member holding unit 301 formed in the second lens holding frame 300 has a surface in contact with the biasing spring 242, a biasing member receiving portion 211 formed in the biasing barrel 210 has a surface in contact with the biasing spring 242, and a plane substantially perpendicular to the biasing direction of the biasing member 240 is formed at each of these surfaces. Thus, as in the first exemplary embodiment described above, a biasing force is generated in the direction of rotation about the optical-axis direction or the optical axis in the biasing barrel 210 and the second lens holding frame 300. This biasing force makes it possible to hold the second lens holding base 200, the second lens holding frame 300, and the biasing barrel 210 in a cam barrel in which a cam groove is formed and a guide barrel in which a guide groove is formed, while controlling backlash, in a lens apparatus of the present exemplary embodiment as well.

### Imaging Apparatus

FIG. 17 is a schematic diagram illustrating the imaging apparatus 1000 including the interchangeable lens 100 according to an exemplary embodiments of the present disclosure. The imaging apparatus 1000 includes the interchangeable lens 100 that is the lens apparatus, and the camera body 400 to which the interchangeable lens 100 is detachably attached with a mount. The camera body 400 includes a control unit, an image sensor, and a contact that can communicate with the interchangeable lens 100. The imaging apparatus 1000 in any of the exemplary embodiments of the present disclosure is not limited to the imaging system, and examples thereof include a camera having an interchangeable lens, and a camera having a built-in lens. Examples of the camera include imaging apparatuses such as a digital still camera and a video camera.

The interchangeable lens 100 houses an image-capturing optical system that forms an optical image of an object (a subject). An image-capturing light beam from the object passes through the image-capturing optical system and forms an image on a light receiving surface (an imaging plane) of an image sensor. The image sensor photoelectrically converts the optical image of the object formed by the image-capturing optical system.

According to the exemplary embodiments of the present disclosure, it is possible to control backlash between a plurality of components and reduce the size of the lens apparatus. While the exemplary embodiments of the present disclosure have been described, the present disclosure is not limited to these exemplary embodiments, and can be modified and changed in various manners within the scope of the spirit thereof.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-059448, filed Mar. 31, 2022, which is hereby incorporated by reference herein in its entirety.

What is claimed is:

1. A lens apparatus comprising:
a lens holding member configured to hold a lens;
a first movement member configured to hold the lens holding member and to move in an optical-axis direction together with the lens holding member;
a guide member having a straight groove; and
a cam member having a cam groove and configured to rotate with respect to the guide member,
wherein the first movement member includes a cam follower configured to engage with the straight groove and the cam groove, and moves in the optical-axis direction by relative rotation of the cam member to the guide member;
a second movement member configured to move in the optical-axis direction together with the lens holding member and the first movement member; and
a biasing member configured to bias the lens holding member to the second movement member so that the cam follower is biased to the straight groove and the cam groove.

2. The lens apparatus according to claim 1,
wherein rotation of the second movement member about an optical axis is limited with respect to the first movement member, and
wherein the biasing member biases the lens holding member in a direction along the optical axis and a direction perpendicular to the optical axis.

3. The lens apparatus according to claim 1,
wherein the first movement member has a holding member configured to hold the lens holding member, and
wherein, in a case where the lens apparatus is viewed in a direction along an optical axis, an angle formed by a line linking the holding member and the optical axis and a line linking the cam follower of the first movement member and the optical axis falls within 30 degrees.

4. The lens apparatus according to claim 1,
wherein the first movement member has a holding member configured to hold the lens holding member, and
wherein, in a case where the lens apparatus is viewed in a direction along an optical axis, the biasing member is between a line linking the cam follower of the first movement member and the optical axis and a line linking the holding member and the optical axis.

5. The lens apparatus according to claim 1, wherein, in a case where the lens apparatus is viewed in a direction along an optical axis, a position of the cam follower of the first movement member and a position of the biasing member in a circumferential direction are different.

6. The lens apparatus according to claim 1,
wherein the first movement member has a holding member configured to hold the lens holding member, and
wherein a distance between a position of the cam follower in the optical-axis direction and a barycenter of the first movement member and a member held by the first movement member is the same as a distance between the holding member and a barycenter of the lens holding member and a member held by the lens holding member.

7. The lens apparatus according to claim 1, wherein the second movement member has an abutment surface configured to abut the biasing member, and the abutment surface is inclined with respect to an optical axis.

8. The lens apparatus according to claim 1, wherein at least one of the lens holding member and the second movement member has a holding unit configured to hold the biasing member.

9. The lens apparatus according to claim 1, wherein the biasing member includes a compression coil spring.

10. The lens apparatus according to claim 1,
wherein the first movement member has a holding member configured to hold the lens holding member, and
wherein the holding member has a holding frame fitting portion fitting to the lens holding member, and a base fitting portion fitting to the first movement member and decentered with respect to the holding frame fitting portion, and the holding member is configured to be used to adjust a position of the lens holding member.

11. An imaging apparatus comprising:
a lens apparatus; and
an image sensor configured to receive light from the lens apparatus,
wherein the lens apparatus includes:
a lens holding member configured to hold a lens;
a first movement member configured to hold the lens holding member and to move in an optical-axis direction together with the lens holding member;
a guide member having a straight groove; and
a cam member having a cam groove and configured to rotate with respect to the guide member, wherein the first movement member includes a cam follower configured to engage with the straight groove and the cam groove, and moves in the optical-axis direction by relative rotation of the cam member to the guide member,
a second movement member configured to move in the optical-axis direction together with the lens holding member and the first movement member, and
a biasing member configured to bias the lens holding member to the second movement member so that the cam follower is biased to the straight groove and the cam groove.
